(19) United States
(12) Patent Application Publication
(10) Pub. No.: US 2024/0385788 A1
(43) Pub. Date: Nov. 21, 2024

(54) PRINT MANAGEMENT APPARATUS AND METHOD THEREOF

(71) Applicant: CANON KABUSHIKI KAISHA, Tokyo (JP)

(72) Inventor: DAIKI KIRIYAMA, Kanagawa (JP)

(21) Appl. No.: 18/662,699

(22) Filed: May 13, 2024

(30) Foreign Application Priority Data
May 19, 2023 (JP) 2023-083307

(51) Int. Cl. G06F 3/12

(52) U.S. Cl. CPC G06F 3/1237

(57) ABSTRACT

A print management apparatus includes a first association unit and a second association unit, and if there is a document approved for printing and there is no reservation identifier associated with a first account, the first association unit issues a new reservation identifier and associates the new reservation identifier with the document approved for printing, and if there is a document approved for printing and there is a reservation identifier associated with the first account and the document associated with the reservation identifier has not been printed, the second association unit associates the reservation identifier with the document approved for printing.

### BACKGROUND

### Field of the Disclosure

The present disclosure relates to print management techniques.

### Description of the Related Art

In recent years, multi-function apparatus vendors are developing solutions for managing printing of documents in the cloud. Not only office equipment and home appliances but also many public multi-function apparatuses installed in convenience stores or shared offices are managed using the cloud. For example, to perform private printing at a convenience store, a document is uploaded to a dedicated mobile application for the convenience store, and a reservation number is transmitted to a user of the application. The user can print the document by inputting the reservation number to a multi-function apparatus at the convenience store.

In printing a plurality of documents, some specifications require the documents to be uploaded through several separate uploads, and one reservation number is issued for each document in some cases. In this case, each reservation number needs to be input for each document to print the plurality of documents, making it take a longer operation time of the multi-function apparatus.

Japanese Patent Application Laid-Open No. 2006-48434 discusses a technique that allows batch printing of documents uploaded consecutively within a predetermined period by inputting one reservation number.

With the recent increase in telework and use of shared offices, not only private but also official use of public multi-function apparatuses by employees of companies are under consideration.

A document to be printed by an employee contains confidential information in some cases, so that approval from a supervisor may be required to print the document using a public multi-function apparatus. In this approval-based printing, a reservation number is likely to be issued upon receiving approval from the supervisor. Thus, when documents are uploaded through several separate uploads and a printing approval request is issued for each document, there can be an interval between the approval timings for the documents. In this case, use of the technique discussed in Japanese Patent Application Laid-Open No. 2006-48434 results in issuing a plurality of reservation numbers. Specifically, the employee needs to input the plurality of reservation numbers to the multi-function apparatus against the intention of the employee due to the influence of the approver, degrading the convenience.

### SUMMARY

According to embodiments of the present disclosure, a print management apparatus includes one or more processors, and one or more memories storing instructions, which when executed by the one or more processors, cause the print management apparatus to receive, from a first account, a first printing request for a document to a second account; transmit, to the second account, a first printing approval request for the document based on the first printing request; receive, from the second account, first printing approval as a response to the first printing approval request; manage the document corresponding to the first printing approval in association with a first reservation identifier; transmit, to the first account, the first reservation identifier; receive, from the first account, a second printing request for another document to the second account; transmit, to the second account, a second printing approval request for the other document based on the second printing request; receive, from the second account, second printing approval as a response to the second printing approval request; and in a case where the document associated with the first reservation identifier has not been printed, manage the first reservation identifier in further association with the other document corresponding to the second printing approval, wherein the first reservation identifier is an identifier to be input to an image forming apparatus to cause the image forming apparatus to print one or more documents associated with the identifier.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of a print system according to a first exemplary embodiment.

FIGS. 2A and 2B are diagrams illustrating an example of configurations of client terminals and a print management cloud service according to the first exemplary embodiment.

FIG. 3 is a diagram illustrating an example of a hardware configuration of a multi-function apparatus according to the first exemplary embodiment.

FIG. 4 is a diagram illustrating an example of a functional configuration of the print system according to the first exemplary embodiment.

FIG. 5 is a flowchart illustrating a procedure of processing of the print management cloud service according to the first exemplary embodiment.

FIGS. 6A to 6C are diagrams illustrating emails transmitted to a client terminal according to the first exemplary embodiment.

FIG. 7 is a sequence diagram illustrating a procedure of processing of the print system according to the first exemplary embodiment.

FIGS. 8A and 8B are diagrams illustrating application user interfaces (application UIs) displayed on a client terminal according to the first exemplary embodiment.

FIG. 9 is a diagram illustrating an application user interface (application UI) displayed on a client terminal according to the first exemplary embodiment.

FIG. 10 is a sequence diagram illustrating a procedure of processing of the print system according to the first exemplary embodiment.

FIG. 11 is a diagram illustrating an application UI displayed on the multi-function apparatus according to the first exemplary embodiment.

FIGS. 12A to 12C are diagrams illustrating an example of structures of data managed by the print management cloud service according to the first exemplary embodiment.

FIG. 13 is a sequence diagram illustrating a procedure of processing of a print system according to a second exemplary embodiment.

FIGS. 14A and 14B are diagrams illustrating emails transmitted to a client terminal according to the second exemplary embodiment.

FIG. 15 is a sequence diagram illustrating a flow of processing of a print system according to a third exemplary embodiment.

FIG. 16 is a diagram illustrating an example of structures of data managed by the print management cloud service according to the third exemplary embodiment.

### DESCRIPTION OF THE EMBODIMENTS

Exemplary embodiments of the present disclosure will be described with reference to the drawings. The exemplary embodiments described below are not intended to limit the disclosure, and not all combinations of features according to the exemplary embodiments are used for technical solutions.

### [System Configuration]

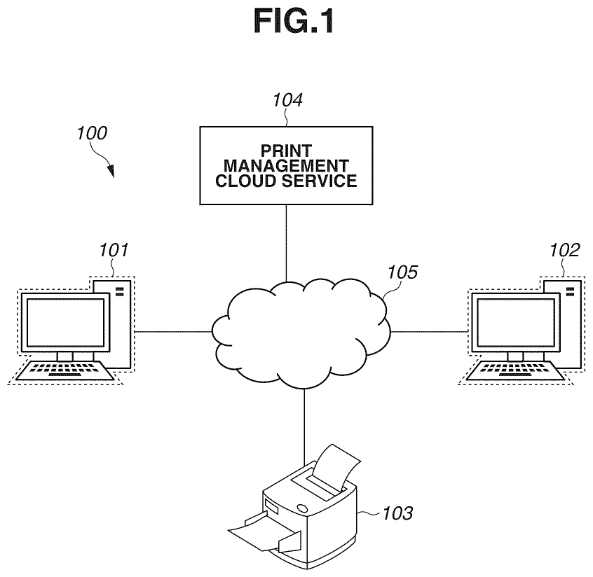

FIG. 1 is a diagram illustrating an example of a configuration of a print system 100 according to a first exemplary embodiment. The print system 100 includes client terminals 101 and 102, a multi-function apparatus 103, and a print management cloud service 104. The client terminals 101 and 102, the multi-function apparatus 103, and the print management cloud service 104 are connected to a network 105.

The client terminal 101 is a client terminal that allows upload of documents to the print management cloud service 104 and receipt of notifications from the print management cloud service 104.

The client terminal 102 is a client terminal that allows receipt of printing approval requests for documents from the print management cloud service 104 and printing approval determination for the documents. The client terminals 101 and 102 are, for example, personal computers or smartphones.

The multi-function apparatus 103 is a multi-function apparatus with a plurality of functions, such as scanner and printer functions. Further, when a reservation number issued by the print management cloud service 104 is received, the multi-function apparatus 103 executes jobs associated with the reservation number and prints a document.

The print management cloud service 104 is a print service with a function of managing documents uploaded from the client terminal 101 as jobs and an approval printing function of performing printing approval management on execution of the jobs. The print management cloud service 104 is an example of print management apparatuses.

The foregoing configuration allows the client terminal 101 to transmit documents to the print management cloud service 104, and the client terminal 102 to perform printing approval determination on the documents. Further, when a document is approved for printing by the client terminal 102, the client terminal 101 receives a reservation number associated with a job of the document from the print management cloud service 104. The reservation number is input to the multi-function apparatus 103, making it possible for the multi-function apparatus 103 to print the document transmitted from the client terminal 101 to the print management cloud service 104.

According to the present exemplary embodiment, the client terminals 101 and 102 and the multi-function apparatus 103 collaborate with the print management cloud service 104 using an authentication and authorization method, such as Open Authorization (OAuth).

The client terminals 101 and 102, the multi-function apparatus 103, and the print management cloud service 104 are connected to communicate with each other via the network 105.

For example, the network 105 is the Internet, a local area network (LAN), a wide area network (WAN), a telephone line, or a communication network as a combination thereof. It is sufficient that the network 105 is capable of transmitting and receiving data only.

### [Hardware Configurations of Client Terminals and Print Management Cloud Service]

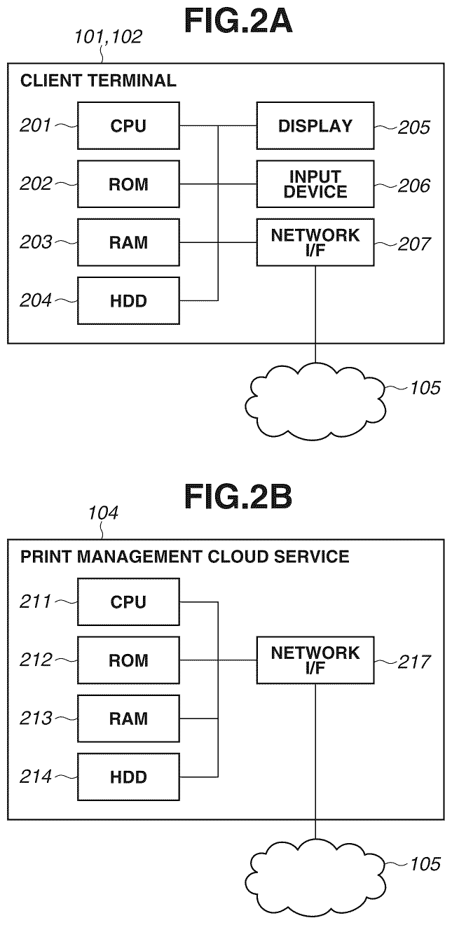

FIG. 2A is a diagram illustrating an example of a hardware configuration of the client terminals 101 and 102 illustrated in FIG. 1. The client terminals 101 and 102 each include a central processing unit (CPU) 201, a read-only memory (ROM) 202, a random access memory (RAM) 203, a hard disk drive (HDD) 204, a display 205, an input device 206, and a network interface (network I/F) 207.

The CPU 201 controls entire operations by reading control programs stored in the ROM 202 and executing various types of processing. The RAM 203 is used as a temporary storage area, such as a main memory of the CPU 201 and a work area. The HDD 204 is a high-capacity storage unit for storing image data and various programs. The display 205 displays various types of information. The input device 206 is a pointing device, such as a mouse or a keyboard, and is used for inputting various types of information. The network I/F 207 is an interface for connecting the client terminals 101 and 102 to the network 105. The client terminals 101 and 102 and the print management cloud service 104 receive processing requests from each other and transmit and receive various types of information to and from each other via the network I/F 207.

FIG. 2B is a diagram illustrating an example of a hardware configuration of the print management cloud service 104 illustrated in FIG. 1. The print management cloud service 104 includes a CPU 211, a ROM 212, a RAM 213, an HDD 214, and a network I/F 217.

The CPU 211, the ROM 212, the RAM 213, and the HDD 214 are respectively similar to the CPU 201, the ROM 202, the RAM 203, and the HDD 204 illustrated in FIG. 2A.

The network I/F 217 is an interface for connecting the print management cloud service 104 to the network 105. The client terminals 101 and 102 and the print management cloud service 104 receive processing requests from each other and transmit and receive various types of information to and from each other via the network I/Fs 207 and 217.

### [Hardware Configuration of Multi-Function Apparatus]

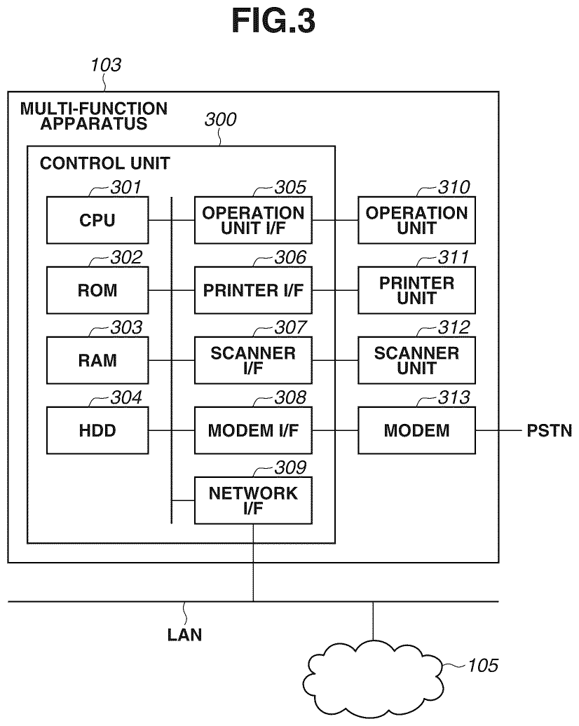

FIG. 3 is a diagram illustrating an example of a hardware configuration of the multi-function apparatus 103 illustrated in FIG. 1. The multi-function apparatus 103 includes a control unit 300, an operation unit 310, a printer unit 311, a scanner unit 312, and a modem 313. The control unit 300 includes a CPU 301, a ROM 302, a RAM 303, an HDD 304, an operation unit interface (operation unit I/F) 305, a scanner interface (scanner I/F) 307, a modem interface (modem I/F) 308, and a network I/F 309 and controls operations of the multi-function apparatus 103.

The CPU 301 reads control programs stored in the ROM 302 and executes and controls various functions of the multi-function apparatus 103, such as reading, printing, and communication functions. The RAM 303 is used as a temporary storage area, such as a main memory of the CPU 301 and a work area.

While one CPU 301 executes processes illustrated in flowcharts described below using one memory (the RAM 303 or the HDD 304) according to the present exemplary embodiment, the present disclosure is not limited to this configuration. For example, a plurality of CPUs and a plurality of RAMs or HDDs can cooperate together to execute the processes.

The HDD 304 is a high-capacity storage unit for storing image data and various programs. The operation unit I/F 305 is an interface for connecting the operation unit 310 and the control unit 300 together. The operation unit 310 includes a touch panel and a keyboard and receives user operations, user inputs, and user instructions.

A printer I/F 306 is an interface for connecting the printer unit 311 and the control unit 300 together. Image data for printing is transferred from the control unit 300 to the printer unit 311 via the printer I/F 306 and is printed on a recording medium.

The scanner I/F 307 is an interface for connecting the scanner unit 312 and the control unit 300 together. The scanner unit 312 scans a document placed on a platen glass (not illustrated) or an auto document feeder (ADF) (not illustrated), generates image data, and inputs the image data to the control unit 300 via the scanner I/F 307. The multi-function apparatus 103 is capable of printing (copying) image data generated by the scanner unit 312 using the printer unit 311 and is also capable of transmitting files or emails.

The modem I/F 308 is an interface for connecting the modem 313 and the control unit 300 together. The modem 313 communicates image data to facsimile apparatuses on a public switched telephone network (PSTN) via facsimile communication.

The network I/F 309 is an interface connecting the control unit 300 (the multi-function apparatus 103) to a LAN. The multi-function apparatus 103 transmits image data and information to services on the network 105 and receives various types of information from the services via the network I/F 309.

### [Functional Configuration of Entire System]

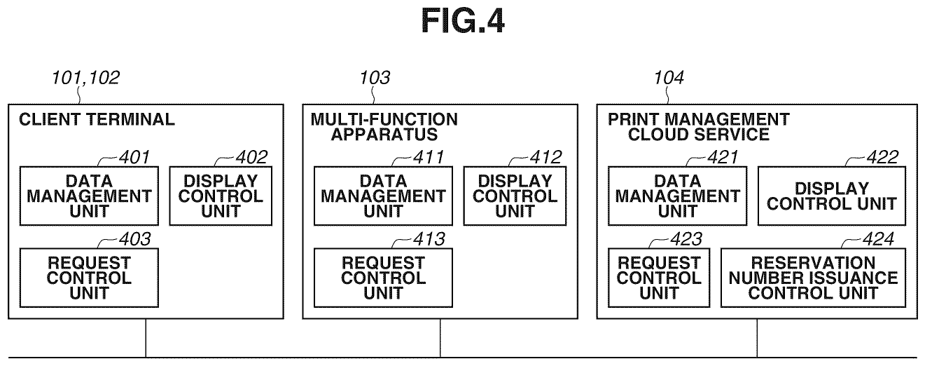

FIG. 4 is a diagram illustrating an example of functional configurations of the client terminals 101 and 102, the multi-function apparatus 103, and the print management cloud service 104 illustrated in FIG. 1.

The client terminals 101 and 102 each include a data management unit 401, a display control unit 402, and a request control unit 403.

The data management unit 401 holds documents to be transmitted to the print management cloud service 104.

The display control unit 402 receives requests from applications running on the client terminal 101 or 102 and returns screen configuration information for screen display. On the client terminal 101, the user operates an application screen via the display control unit 402, selects documents, and performs an operation to transmit the documents to the print management cloud service 104. Further, if the documents are approved for printing by the client terminal 102, the client terminal 101 displays the printing approval determination results, a reservation number, and a printable document list through the display control unit 402. On the client terminal 102, the user operates an application screen through the display control unit 402 and performs a document printing approval operation.

The request control unit 403 issues various processing requests to the print management cloud service 104. For example, the request control unit 403 issues a request to log in to a service, a request to transmit or receive a document, or a request to update a printing approval status of a document.

The multi-function apparatus 103 includes a data management unit 411, a display control unit 412, and a request control unit 413.

The data management unit 411 stores documents downloaded from the print management cloud service 104 in the HDD 304.

The display control unit 412 performs control to display the progress of printing processing or a user interface (UI) screen for receiving user operations on a liquid crystal display unit of the operation unit 310 of the multi-function apparatus 103 that has a touch panel function. For example, the display control unit 412 performs control to display a menu for inputting a reservation number to access the print management cloud service 104, configuring print settings, or presenting printable documents.

The request control unit 413 issues various processing requests to the print management cloud service 104. For example, the request control unit 413 issues a request to access a document using a reservation number or a request to acquire document image data.

The print management cloud service 104 includes a data management unit 421, a display control unit 422, a request control unit 423, and a reservation number issuance control unit 424.

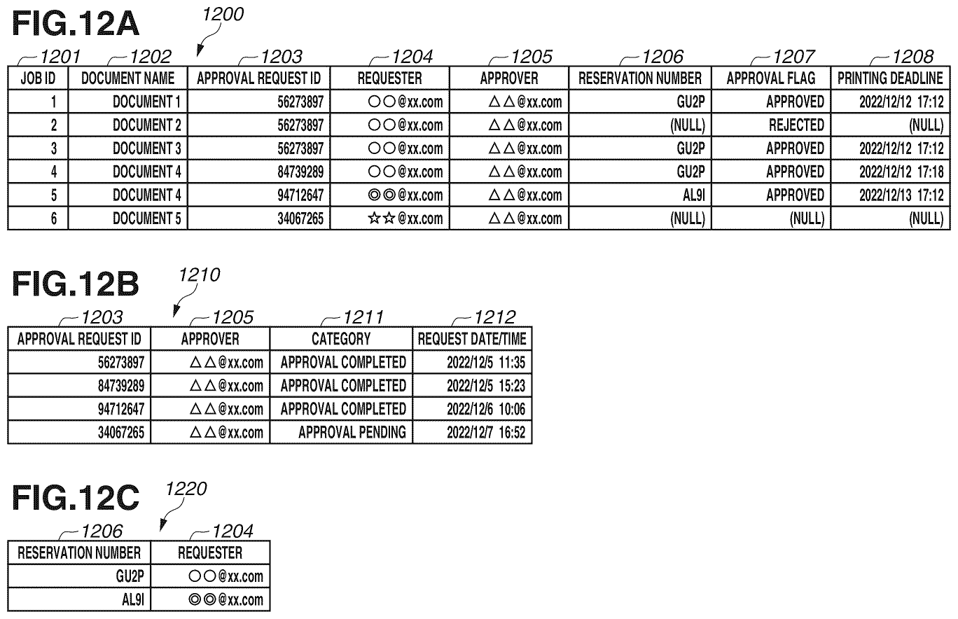

The data management unit 421 holds documents stored in the print management cloud service 104. Further, the data management unit 421 manages a list (document job list 1200 in FIG. 12A) of jobs of documents transmitted from the client terminal 101. Further, the data management unit 421 manages a list (printing approval request list 1210 in FIG. 12B) of printing approval requests transmitted to the client terminal 102 and a list (reservation number list 1220 in FIG. 12C) of reservation numbers issued by the reservation number issuance control unit 424.

The display control unit 422 receives requests from web browsers running on the client terminal 101 or 102 or the multi-function apparatus 103 and returns screen configuration information (Hypertext Markup Language (HTML) information, Cascading Style Sheets (CSS) information) for screen display. The user can refer to documents stored in the print management cloud service 104 and printing approval statuses via screens displayed by the web browsers.

The request control unit 423 performs processing based on processing requests from the client terminal 101 or 102 or the multi-function apparatus 103 on a timely basis and returns results of the processing requests to the client terminal 101 or 102 or the multi-function apparatus 103. For example, when a printing approval request is received from the client terminal 101, the request control unit 423 transmits the printing approval request to the client terminal 102.

Further, when the client terminal 102 performs printing approval determination for documents, the request control unit 423 updates the document job list 1200 illustrated in FIG. 12A. Thereafter, the request control unit 423 transmits printing approval determination results, a reservation number, and a printable document list to the client terminal 101. Further, if a document transmission request is received from the multi-function apparatus 103, the request control unit 423 transmits the document transmission request to the multi-function apparatus 103.

The reservation number issuance control unit 424 refers to the document job list 1200 and the reservation number list 1220 managed by the data management unit 421 and determines whether to issue a new reservation number.

A method will now be described for solving the above-described issue, i.e., a plurality of reservation numbers is transmitted to the client terminal 101 due to an interval between the approval timings for the documents.

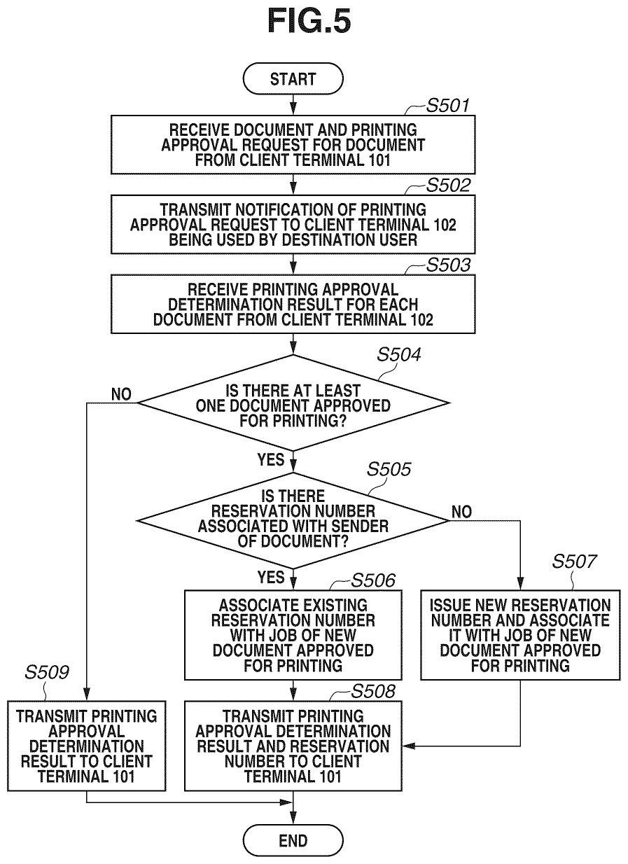

FIG. 5 is a flowchart illustrating a procedure of processing of the print management cloud service 104.

The series of processing in the flowchart is performed by the CPU 211 executing control programs stored in the HDD 214. A method of the processing of the print management cloud service 104 will be described in detail.

In step S501, the CPU 211 receives documents and a printing approval request for the documents from the client terminal 101 via the network I/F 217. The CPU 211 stores the documents and the printing approval request received in step S501 using the data management unit 421. The CPU 211 issues a new approval request ID 1203 and adds an approval request record to the printing approval request list 1210 illustrated in FIG. 12B. Further, the CPU 211 issues a job for each received document and adds the jobs as job records to the document job list 1200 illustrated in FIG. 12A. Thereafter, the CPU 211 associates each job record added to the document job list 1200 with the newly issued approval request ID 1203.

In step S502, the CPU 211 transmits a notification of the printing approval request to the client terminal 102 being used by a user corresponding to a destination (of an approver 1205) set in the printing approval request in FIG. 12B.

In step S503, the CPU 211 receives a printing approval determination result for each document from the client terminal 102. The CPU 211 updates fields of an approval flag 1207 of the corresponding job records in the document job list 1200 based on the printing approval determination results. For each job record with the field of the approval flag 1207 updated to “approved”, the CPU 211 sets a date/time in a predetermined period after the approval date/time in the corresponding field of a printing deadline 1208 at the same timing. When the date/time set in the field of the printing deadline 1208 of a job record passes, the CPU 211 deletes the job record from the document job list 1200.

In step S504, the CPU 211 determines whether there is at least one document approved for printing among the documents for which the printing approval request has been issued. The CPU 211 queries the document job list 1200 and searches for job records with the approval request ID generated newly in step S501 in the field of the approval request ID 1203. The CPU 211 determines whether the job records include at least one job record with “approved” in the field of the approval flag 1207. If there is at least one document approved for printing (YES in step S504), the processing proceeds to step S505, whereas if there is no document approved for printing (NO in step S504), the processing proceeds to step S509.

In step S505, the CPU 211 determines whether there is a previously-issued reservation number associated with the user using the client terminal 101 as the sender of the document. The CPU 211 queries the reservation number list 1220 illustrated in FIG. 12C and determines whether there is a reservation number record with a user account of the client terminal 101 set in a field of a requester 1204. If there is such a reservation number (YES in step S505), the processing proceeds to step S506, whereas if there is no such reservation number (NO in step S505), the processing proceeds to step S507.

In step S506, the CPU 211 associates the reservation number 1206 associated with the user of the client terminal 101 and stored in the reservation number list 1220 with the job records of the newly approved documents for printing. This allows printing of the newly approved documents for printing by inputting the reservation number 1206 to the multi-function apparatus 103. Thereafter, the processing proceeds to step S508.

In step S507, the CPU 211 issues a new reservation number 1206 using the reservation number issuance control unit 424 and adds a reservation number record to the reservation number list 1220. The CPU 211 avoids issuing a new reservation number 1206 that matches an existing reservation number 1206. Thereafter, the CPU 211 associates the newly issued reservation number 1206 with the job records of the newly approved documents for printing. Thereafter, the processing proceeds to step S508.

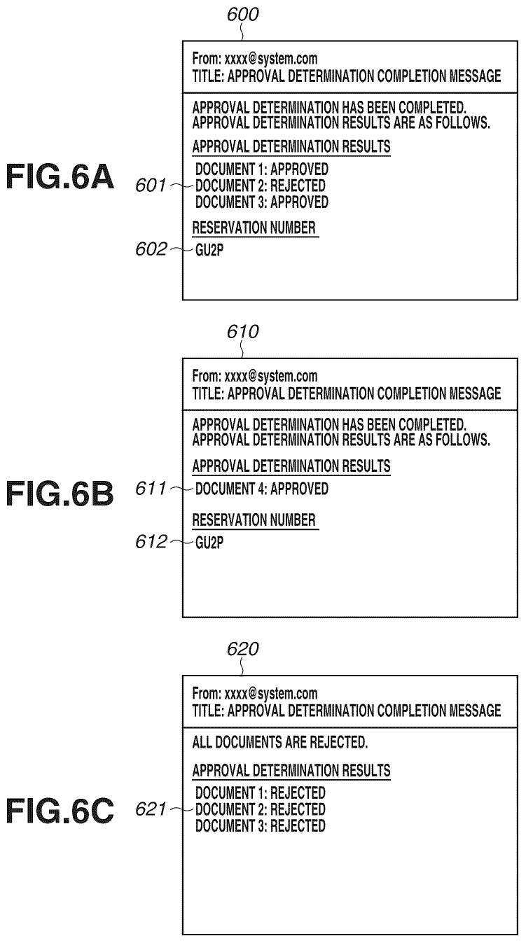

In step S508, the CPU 211 transmits, to the client terminal 101, the printing approval determination result for each document and the reservation number to be input to the multi-function apparatus 103 to allow printing of the documents approved for printing. FIGS. 6A and 6B illustrate emails 600 and 610 transmitted to the client terminal 101 by the CPU 211. When a new reservation number is issued by the CPU 211, the email 600 is transmitted to the client terminal 101. The email 600 includes printing approval determination results 601 and a reservation number 602. When another document is newly approved for printing in a state where the documents approved for printing at the time of receiving the email 600 have not been printed, the email 610 is transmitted to the client terminal 101. The email 610 includes a printing approval determination result 611 and a reservation number 612. At this time, the reservation number 612 is the same text string as the reservation number 602.

In step S509, the CPU 211 transmits only the document printing approval determination results to the client terminal 101. If all documents for which a printing approval request has been issued by the client terminal 101 are rejected, an email 620 illustrated in FIG. 6C is transmitted to the client terminal 101. The email 620 only includes printing approval determination results 621 and includes no reservation number.

While printing approval determination results and reservation numbers are transmitted to the client terminal 101 by email according to the present exemplary embodiment, a short message service (SMS) or message applications are used in some embodiments.

### [Sequence Diagram Up to Reception of Reservation Number by Client Terminal 101]

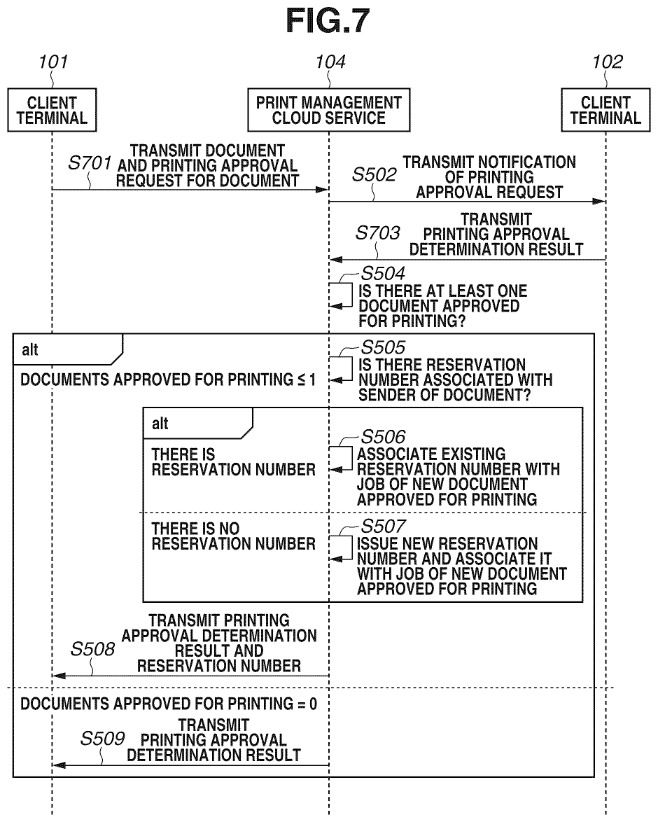

FIG. 7 is a sequence diagram illustrating a procedure of processing between the client terminals 101 and 102 and the print management cloud service 104.

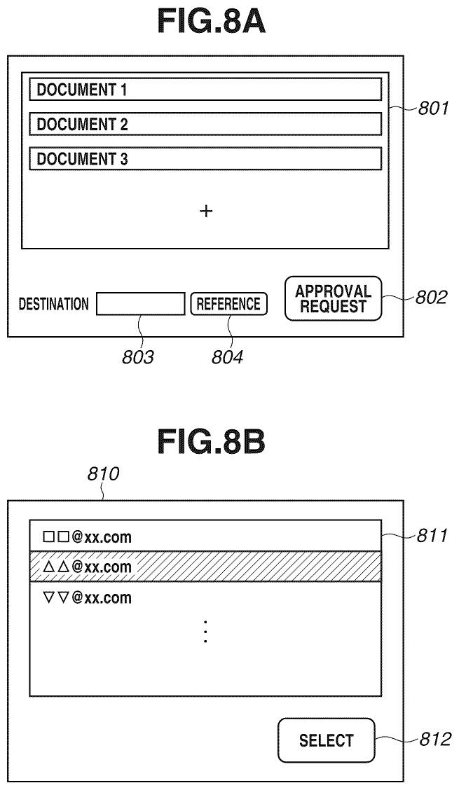

In step S701, the client terminal 101 transmits documents and a printing approval request for the documents to the print management cloud service 104. FIG. 8A illustrates a screen displayed at this time on the display 205 of the client terminal 101. When a document stored in the client terminal 101 is dragged and dropped into a document box 801, the document is added to the document box 801. A click operation on an approval request button 802 causes the documents and a printing approval request for the documents to be transmitted from the client terminal 101 to the print management cloud service 104. At this time, if the document box 801 and a destination box 803 are in an empty state, a transmission error occurs. A click operation on a reference button 804 causes a screen 810 illustrated in FIG. 8B to be displayed. A click operation on a select button 812 with one account selected from a destination candidate menu 811 causes the account to be displayed in the destination box 803. In other embodiments, a document that is dragged and dropped into the document box 801 is a document stored in the print management cloud service 104.

In step S502, the print management cloud service 104 transmits a notification of the printing approval request to the client terminal 102 being used by the user corresponding to the destination set in the printing approval request.

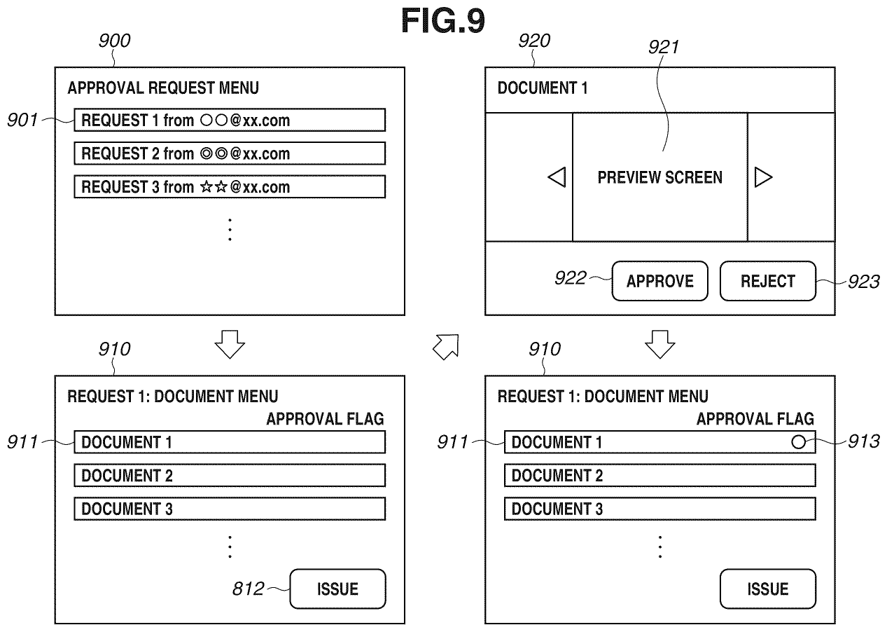

In step S703, the client terminal 102 performs printing approval determination to determine whether to approve or reject printing of each document and transmits printing approval determination results to the print management cloud service 104. FIG. 9 illustrates screens displayed at this time on the display 205 of the client terminal 102. When the print management cloud service 104 transmits a notification of the printing approval request to the client terminal 102 in step S502, a request button 901 is added to an approval request menu 900. The request button 901 specifies a user account of the client terminal 101 that is the requester of the printing approval request. A click operation on the request button 901 causes a document menu 910 to display a list of documents transmitted from the client terminal 101 to the print management cloud service 104. A click operation on a document button 911 causes a printing approval screen 920 for the corresponding document to be displayed. The user can determine whether to approve printing of the document by browsing a preview screen 921. A click operation on an approve button 922 adds an approval flag 913 to the document button 911. Further, a click operation on a reject button 923 causes an approval flag 913 differing from the approval flag 913 added at the time of clicking the approve button 922 is added to the document button 911. The approval flag 913 can be in any form having different patterns for different cases where the approve button 922 is clicked or the reject button 923 is clicked.

The processes in steps S504 to S509 in FIG. 7 correspond to those in steps S504 to S509 in FIG. 5.

### [Document Printing Flowchart]

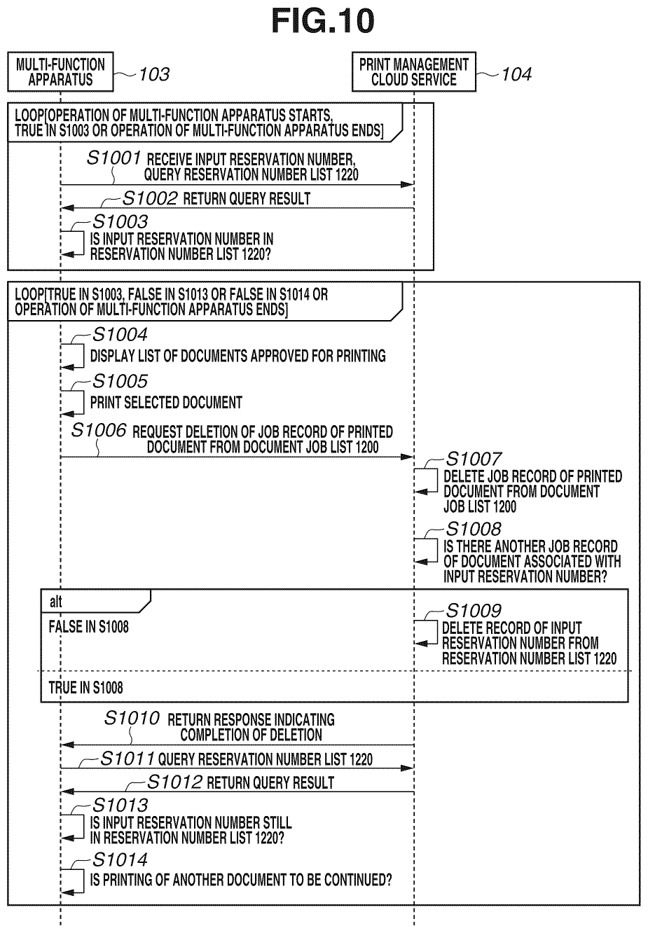

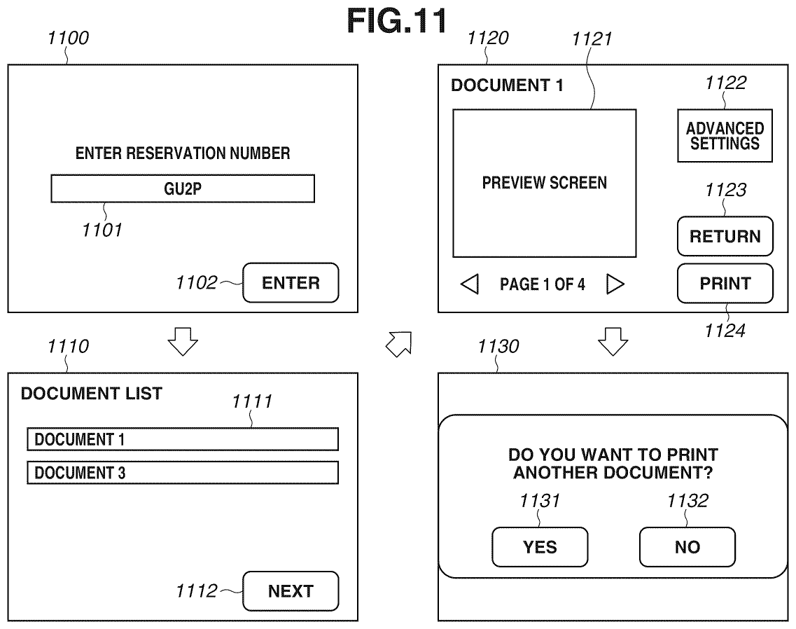

FIG. 10 is a sequence diagram illustrating a procedure of processing between the multi-function apparatus 103 and the print management cloud service 104. The series of processing of the multi-function apparatus 103 in the sequence diagram is performed by the CPU 301 executing control programs stored in the HDD 304. FIG. 11 illustrates transitions between UIs of the multi-function apparatus 103. Details thereof will be described.

In step S1001, the multi-function apparatus 103 receives a reservation number from the user of the client terminal 101. At this time, the multi-function apparatus 103 displays a reservation number reception screen 1100 illustrated in FIG. 11. The user operates the operation unit 310 and inputs a reservation number in a reservation number box 1101. Thereafter, when the user presses an enter button 1102, the multi-function apparatus 103 queries the reservation number list 1220 of the print management cloud service 104. At this time, the multi-function apparatus 103 queries whether a reservation number record of the input reservation number is in the reservation number list 1220.

In step S1002, the print management cloud service 104 returns a query result to the multi-function apparatus 103.

In step S1003, the multi-function apparatus 103 determines whether a reservation number record of the reservation number input in step S1001 is in the reservation number list 1220 based on the query result returned in step S1002. If a reservation number record is in the reservation number list 1220, the processing proceeds to step S1004, whereas if no reservation number record is in the reservation number list 1220, the processing returns to step S1001.

In step S1004, the multi-function apparatus 103 displays a printable document list 1110 illustrated in FIG. 11. When a “next” button 1112 is pressed with a document button 1111 selected, the display changes to a print settings screen 1120. While a preview screen 1121 is displayed, an advanced settings button 1122 is pressed as appropriate, and print settings are changed. When a “return” button 1123 is pressed, the display returns to the document list 1110, whereas when a print button 1124 is pressed, the processing proceeds to step S1005. While only one document is selected according to the present exemplary embodiment, a plurality of document buttons 1111 can be selected for batch printing using the same print settings.

In step S1005, the multi-function apparatus 103 executes a job of the document selected in step S1003 and prints the selected document in the print management cloud service 104. Thereafter, the processing proceeds to step S1006.

In step S1006, the multi-function apparatus 103 requests the print management cloud service 104 to delete the job record of the printed document from the document job list 1200.

In step S1007, the print management cloud service 104 deletes the job record of the printed document from the document job list 1200.

In step S1008, the print management cloud service 104 determines whether another job record of a document associated with the reservation number input to the multi-function apparatus 103 in step S1001 is in the document job list 1200. If there is another job record (YES in step S1008), the processing proceeds to step S1009, whereas if there is no other job record (NO in step S1008), the processing proceeds to step S1010.

In step S1009, the print management cloud service 104 deletes the reservation number record of the reservation number input to the multi-function apparatus 103 in step S1001 from the reservation number list 1220, and the processing proceeds to step S1010.

In step S1010, the print management cloud service 104 returns a response indicating the completion of deletion of the job record of the document to the multi-function apparatus 103.

In step S1011, the multi-function apparatus 103 queries the reservation number list 1220 of the print management cloud service 104. At this time, the multi-function apparatus 103 queries whether the reservation number input in step S1001 is still in the reservation number list 1220.

In step S1012, the print management cloud service 104 returns a query result to the multi-function apparatus 103.

In step S1013, the multi-function apparatus 103 determines whether another reservation number record of the reservation number input in step S1001 is in the reservation number list 1220 based on the query result returned in step S1012. In this processing, the absence of the reservation number input in step S1001 indicates that there is no job record of another document associated with the reservation number in the document job list 1200. If there is no other reservation number record, the process in FIG. 10 ends, whereas if there is another reservation number record, the processing proceeds to step S1014.

In step S1014, the multi-function apparatus 103 determines whether to continue to print another document based on the user input. At this time, the multi-function apparatus 103 displays a screen 1130 illustrated in FIG. 11. If an “YES” button 1131 is pressed, the processing returns to step S1004. If a “NO” button 1132 is pressed, the process in FIG. 10 ends.

### [Structures and Specifications of Data Managed by Print Management Cloud Service]

FIGS. 12A to 12C illustrate structures of data other than documents that are managed by the data management unit 421 of the print management cloud service 104.

The document job list 1200 is a table to which a job record is added for each document at the time of transmitting a printing approval request for the document from the client terminal 101. The document job list 1200 includes a job ID 1201 as a primary key and columns of a document name 1202, the approval request ID 1203, the requester 1204, the approver 1205, the reservation number 1206, the approval flag 1207, and the printing deadline 1208.

The printing approval request list 1210 is a table to which an approval request record is added for each printing approval request for documents at the time of transmitting the printing approval request from the client terminal 101. The printing approval request list 1210 includes the approval request ID 1203 as a primary key and columns of the approver 1205, a category 1211, and a request date/time 1212.

The reservation number list 1220 is a table to which a record is added for each reservation number when the client terminal 102 approves document printing and the reservation number issuance control unit 424 of the print management cloud service 104 newly issues the reservation number. The reservation number list 1220 includes the reservation number 1206 as a primary key and a column of the requester 1204.

Specifications of the data tables will now be described in detail. When the client terminal 101 transmits a printing approval request for a document, a job record is added to the document job list 1200 with the fields of the reservation number 1206, the approval flag 1207, and the printing deadline 1208 being in a NULL state. While the field of the job ID 1201 is set to one digit according to the present exemplary embodiment, any numerical sequence that is unique in the table can be used.

Further, an approval request record is added to the printing approval request list 1210 with the field of the category 1211 in an “approval pending” state. The request date/time 1212 indicates the time of the addition of the approval request record. Job records of one or more documents for which a printing approval request is issued simultaneously have the same approval request ID 1203 in the fields. The print management cloud service 104 refers to the field of the approver 1205 of the job record of the document and transmits a notification of the printing approval request to the client terminal 102 being used by the user of the account.

If the document is approved for printing by the client terminal 102, the field of the approval flag 1207 of the job record of the document changes to “approved”. At this time, if no reservation number record associated with the requester account specified in the field of the requester 1204 is in the reservation number list 1220, a new reservation number 1206 is issued. Then, a reservation number record of the new reservation number 1206 is added to the reservation number list 1220. The issued reservation number 1206 is set in the field of the reservation number 1206 of the job record of the document approved for printing.

If a reservation number record associated with the requester account specified in the field of the requester 1204 is in the reservation number list 1220, the corresponding reservation number is set in the field of the reservation number 1206. A date/time in a predetermined period after the printing approval is set in the field of the printing deadline 1208.

If the document is rejected for printing by the client terminal 102, the field of the approval flag 1207 of the job record of the document changes to “rejected”. At this time, the fields of the reservation number 1206 and the printing deadline 1208 remain NULL. In some embodiments, the job of the document rejected for printing is deleted immediately from the document job list 1200. Further, in other embodiments, the field of the approval flag 1207 is updated to “approved” within a predetermined period. In this case, the fields of the reservation number 1206 and the printing deadline 1208 of the document are set similarly to newly approved documents for printing. In yet other embodiments, the field of the approval flag 1207 is changed from “approved” to “rejected”. At this time, the fields of the reservation number 1206 and the printing deadline 1208 of the job record of the document are updated to NULL.

When all approval flags 1207 of job records of documents associated with one approval request ID 1203 are updated to “approved” or “rejected”, the field of the category 1211 of the corresponding approval request record in the printing approval request list 1210 is updated to “approval completed”. If the field of the category 1211 remains “approval pending” even in a predetermined period from the request date/time 1212, the print management cloud service 104 can transmit a reminder notification to the client terminal 102.

Each job record in the document job list 1200 is deleted when printing is completed by the multi-function apparatus 103 or after the date/time in the field of the printing deadline 1208. When all job records of documents associated with one reservation number 1206 are deleted from the document job list 1200, the corresponding reservation number record is deleted from the reservation number list 1220. In some embodiments, the reservation number record in the reservation number list 1220 is deleted. In this case, all job records of documents associated with the reservation number set in the field of the reservation number 1206 are deleted from the document job list 1200.

The reservation numbers 1206 are not limited to numbers and can be reservation identifiers. Further, the multi-function apparatus 103 is any apparatus with a print function and is an example of an image forming apparatus.

As described above, in step S701 in FIG. 7, the client terminal 101 of a first account (requester) transmits, to the print management cloud service 104, a printing approval request for one or more documents to a second account (approver).

In step S501 in FIG. 5, the CPU 211 functions as a reception unit and receives the printing approval request for the one or more documents to the second account (approver) from the client terminal 101 of the first account (requester). For example, the CPU 211 receives a printing approval request for documents 1, 2, and 3 illustrated in FIG. 6A. In the following description, it is assumed that a user having the first account sends one or more emails for a printing approval request to the second account by using the client terminal 101.

In step S502, the CPU 211 functions as a transmission unit and transmits the printing approval request for the one or more documents to the client terminal 102 of the second account.

In step S703, the client terminal 102 receives the printing approval request addressed to the second account and transmits, to the print management cloud service 104, a printing approval determination result for each document in response to the printing approval request. In the following description, it is assumed that the user having the second account receives the mail for the printing approval request addressed to the second account by using the client terminal 102.

In step S503, the CPU 211 receives, from the client terminal 102 of the second account, the printing approval determination result for each document in response to the printing approval request for the one or more documents. For example, as illustrated in FIG. 6A, the documents 1 and 3 are approved for printing (approved), and the document 2 is rejected for printing (rejected).

In step S504, if there is an approved document for printing in the printing approval determination results received in step S503, the processing proceeds to step S505. Further, if there is no approved document for printing in the printing approval determination results received in step S503, the processing proceeds to step S509.

In step S505, if the printing approval request is the first printing approval request, there is no reservation number associated with the first account, so that the processing proceeds to step S507.

In step S507, the CPU 211 functions as an association unit and issues a first reservation identifier (reservation number) and associates the first reservation identifier with the document approved for printing. The first reservation identifier is, for example, “GU2P” illustrated as a reservation number 602 in FIG. 6A.

After the associating, in step S508, the CPU 211 transmits, to the first account, the email 600 including a printing approval determination result 601 received for each document in step S503 and the reservation number 602 illustrated in FIG. 6A. In the following description, it is assumed that the user having the first account checks one or more emails addressed to the first account by using the client terminal 101.

Then, in step S501, the CPU 211 receives, from the client terminal 101 of the first account, a printing approval request for one or more other documents to the second account. For example, the CPU 211 receives a printing approval request for a document 4 illustrated in FIG. 6B.

In step S502, the CPU 211 transmits the printing approval request for the one or more other documents to the client terminal 102 of the second account.

In step S503, the CPU 211 receives, from the client terminal 102 of the second account, a printing approval determination result for each document in response to the printing approval request for the one or more other documents. For example, as illustrated in FIG. 6B, the document 4 is approved for printing.

In step S504, if there is an approved document for printing in the printing approval determination results received in step S503 (YES in step S504), the processing proceeds to step S505.

In step S505, if the documents associated with the first reservation identifier (GU2P) have not been printed and there is a first reservation number associated with the first account, the processing proceeds to step S506. Further, if all documents associated with the first reservation identifier (GU2P) have been printed and there is no first reservation number associated with the first account (NO in step S505), the processing proceeds to step S507.

In step S506, the CPU 211 associates the first reservation identifier with the document approved for printing (e.g., document 4).

After the associating, in step S508, the CPU 211 transmits, to the client terminal 101 of the first account, the email 610 including the printing approval determination result 611 received for each document in step S503 and a reservation number 612 illustrated in FIG. 6B. An identifier “GU2P” illustrated the reservation number 612 is input to the multi-function apparatus 103 to cause the multi-function apparatus 103 to print the documents associated with the identifier “GU2P”.

In step S507, the CPU 211 issues a second reservation identifier differing from the first reservation identifier and associates the second reservation identifier with the document approved for printing.

After the associating, in step S508, the CPU 211 transmits, to the client terminal 101 of the first account, an email including the printing approval determination result received for each document in step S503 and the second reservation identifier.

In step S504, if there is no document approved for printing in the printing approval determination results received in step S503, the processing proceeds to step S509.

In step S509, the CPU 211 transmits, to the client terminal 101 of the first account, the email 620 including the printing approval determination result 621 received for each document in step S503 as illustrated in FIG. 6C.

In step S507, the CPU 211 associates the reservation number 1206 with the document name 1202 and the printing deadline 1208 for the document approved for printing as illustrated in FIG. 12A. Further, when the first reservation identifier 1206 is issued, the CPU 211 associates the reservation number 1206 with the first account (requester) 1204 illustrated in FIG. 12C.

In step S1007 in FIG. 10, if the document associated with the first reservation identifier has been printed, the CPU 211 deletes the association between the printed document, the printing deadline for the document, and the first reservation identifier from the job list 1200 in FIG. 12A.

In this case, the CPU 211 functions as a deletion unit. Further, if the printing deadline 1208 for the document associated with the first reservation identifier has expired, the CPU 211 deletes the association between the document, the printing deadline 1208 for the document, and the first reservation identifier from the job list 1200 in FIG. 12A.

In step S1009, if all documents associated with the first reservation identifier have been printed, the CPU 211 deletes the association between the first reservation identifier 1206 and the first account 1204 in FIG. 12C. Further, if all documents associated with the first reservation identifier have been printed or the printing deadline has expired, the CPU 211 deletes the association between the first reservation identifier 1206 and the first account 1204 in FIG. 12C.

In step S504, if the documents associated with the first reservation identifier have not been printed and the printing deadline 1208 has not expired, the job records are still in the document job list 1200, so that the processing proceeds to step S505. Further, if all documents associated with the first reservation identifier have been printed or the printing deadline 1208 has expired, the job records have been deleted from the document job list 1200, so that the processing proceeds to step S509.

Further, in step S505, if there is no reservation identifier 1206 associated with the first account 1204, the processing proceeds to step S507. Further, if there is a reservation identifier 1206 associated with the first account 1204, the documents associated with the reservation identifier 1206 have not been printed, so that the processing proceeds to step S506.

In step S507, the CPU 211 issues a new reservation identifier and associates the new reservation identifier with the document approved for printing. After the associating, in step S508, the CPU 211 transmits, to the client terminal 101 of the first account, the printing approval determination result received for each document in step S503 and the new reservation identifier.

In step S506, the CPU 211 associates the reservation identifier 1206 with the document approved for printing. After the associating, in step S508, the CPU 211 transmits, to the client terminal 101 of the first account, an email including the printing approval determination result received for each document in step S503 and the reservation identifier 1206 associated with the first account 1204.

In step S1005 in FIG. 10, the multi-function apparatus 103 prints the document associated with the reservation identifier 1206 based on the reservation identifier 1206.

In the foregoing method according to the present exemplary embodiment, when a new document is approved for printing in a state where a previously approved document for printing has not been printed, the documents are associated with the same reservation number. Thus, even if a printing approval request is issued a plurality of times, unless the user of the client terminal 101 prints all documents associated with a reservation number, the reservation number can be used continuously. Specifically, a reservation number input operation is performed only once to print the documents regardless of timings of printing approval, providing a reduced operation time per person.

According to the present exemplary embodiment, batch printing can be performed using one reservation number regardless of timings of printing approval unless the user prints all documents associated with the reservation number, so that the user does not have to input a plurality of reservation numbers due to the effect of an approver before starting printing.

A second exemplary embodiment will be described. In the above-described method according to the first exemplary embodiment, the print management cloud service 104 transmits a printing approval determination result for each document and a reservation number to the user of the client terminal 101, and the multi-function apparatus 103 receives the reservation number to print the documents in a batch.

With the method, however, the user of the client terminal 101 cannot identify all documents that are printable by inputting the received reservation number to the multi-function apparatus 103 at the time of receiving the reservation number.

In a method according to the second exemplary embodiment described, in addition to printing approval determination results and a reservation number as in the first exemplary embodiment, a list of documents that are printable by inputting the reservation number to the multi-function apparatus 103 is also transmitted to the client terminal 101. Redundant descriptions of similarities between the second exemplary embodiment and the first exemplary embodiment, such as the configurations of the print system 100 and the application UIs, are omitted.

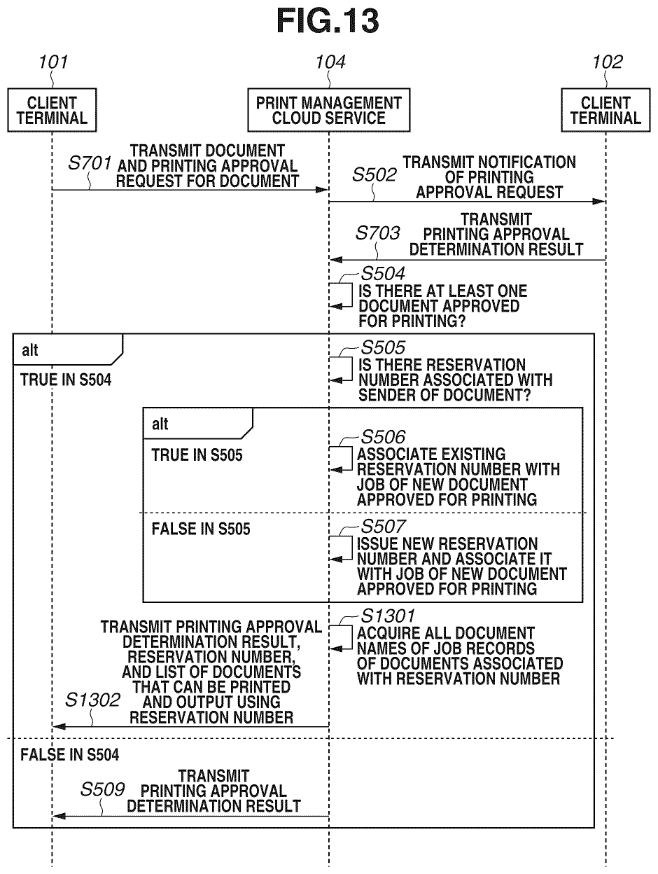

FIG. 13 is a sequence diagram illustrating a procedure of processing between the client terminals 101 and 102 and the print management cloud service 104 according to the second exemplary embodiment. FIG. 13 differs from FIG. 7 in that step S508 is deleted and steps S1301 and S1302 are added.

From step S506, the processing proceeds to step S1301. Further, from step S507, the processing proceeds to step S1301.

In step S1301, the print management cloud service 104 queries the document job list 1200 and acquires all document names 1202 of job records of documents associated with either the existing reservation number or the newly issued reservation number.

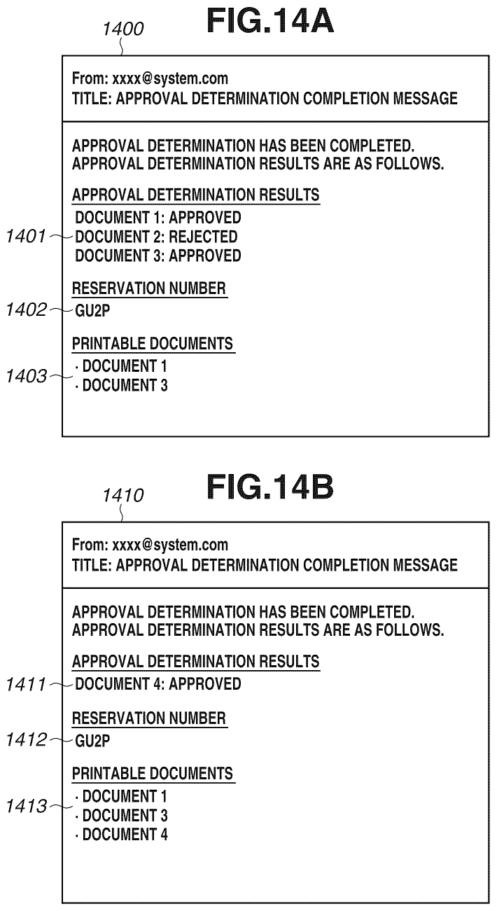

In step S1302, the print management cloud service 104 transmits, to the client terminal 101, a list of the document names 1202 acquired in step S1301 in addition to the printing approval determination result for each document for which the printing approval request has been issued and the reservation number. FIGS. 14A and 14B illustrate emails 1400 and 1410 transmitted from the print management cloud service 104 to the client terminal 101.

When a new reservation number is issued by the print management cloud service 104, the email 1400 is transmitted to the client terminal 101. The email 1400 includes printing approval determination results 1401, a reservation number 1402, and printable documents 1403.

If another document is newly approved for printing in a state where the documents approved for printing at the time of receiving the email 1400 have not been printed, the email 1410 is transmitted to the client terminal 101. The email 1410 includes a new printing approval determination result 1411, a reservation number 1412, and printable documents 1413. The reservation number 1412 is the same text string as the reservation number 1402. The printable documents 1413 are a list including the document approved for printing in the new printing approval determination result 1411 in addition to the printable documents 1403.

Printing approval determination results, a reservation number, and printable documents are transmitted to the client terminal 101 by email according to the present exemplary embodiment. On the other hands, in some embodiments, SMS or message applications are used.

As described above, in step S1302, the CPU 211 transmits the email 1400 or 1410 to the client terminal 101 of the first account. The email 1410 includes the printing approval determination result 1411 received for each document in step S503, the reservation number 1412, and the names of the printable documents 1413 of the documents approved for printing in the printing approval determination results received in step S503.

In the foregoing method according to the present exemplary embodiment, the print management cloud service 104 transmits, to the client terminal 101, printing approval determination results, a reservation number, and a list of documents that are printable by inputting the reservation number to the multi-function apparatus 103. This allows the user of the client terminal 101 to identify printable documents at the time of receiving the reservation number from the print management cloud service 104.

A third exemplary embodiment will be described. In the above-described methods according to the first and second exemplary embodiments, printing approval determination results for documents and a reservation number or printing approval determination results for documents, a reservation number, and a printable document list are transmitted to the client terminal 101, and the multi-function apparatus 103 receives the reservation number to print the documents in a batch. With the methods, however, a reservation number can be used endlessly by not printing at least one document associated with the reservation number. In this case, leakage of the reservation number leads to security issues, e.g., confidential documents can be printed at any time.

In a method according to the third exemplary embodiment, a limit is set for the number of times a job of a document can additionally be associated with one reservation number in addition to the first and second exemplary embodiments. Redundant descriptions of similarities between the third exemplary embodiment and the first and second exemplary embodiments, such as the configurations of the print system 100 and the application UIs, are omitted.

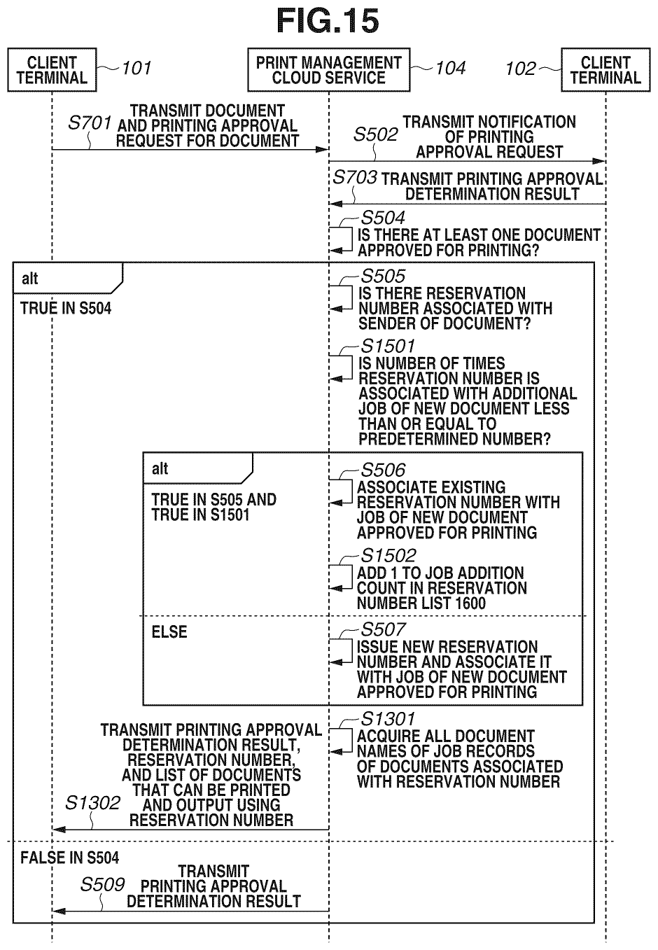

FIG. 15 is a sequence diagram illustrating a procedure of processing between the client terminals 101 and 102 and the print management cloud service 104 according to the third exemplary embodiment. FIG. 15 differs from FIG. 13 in that steps S1501 and S1502 are added.

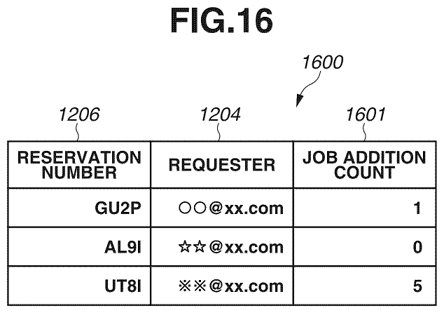

FIG. 16 is a diagram illustrating an example of a data structure of a reservation number list 1600 according to the third exemplary embodiment. The reservation number list 1600 includes the reservation number 1206 as a primary key and columns of the requester 1204 and a job addition count 1601 and is used in place of the reservation number list 1220 illustrated in FIG. 12C. The initial value of the job addition count 1601 is 0.

In step S505, the CPU 211 queries the reservation number list 1600 illustrated in FIG. 16 and determines whether there is a reservation number record with the user account of the client terminal 101 set in the field of the requester 1204. If there is such a reservation number record (YES in step S505), the processing proceeds to step S1501, whereas if there is no such reservation number record (NO in step S505), the processing proceeds to step S507.

In step S1501, the print management cloud service 104 determines whether the job addition count 1601 of the number of times the reservation number referred to in the determination in step S505 is previously associated with an additional job of a newly approved document for printing is less than or equal to a predetermined number. The predetermined number is set by an administrator of the print management cloud service 104. If the job addition count 1601 is less than or equal to the predetermined number, the processing proceeds to step S506, whereas if the job addition count 1601 is not less than or equal to the predetermined number, the processing proceeds to step S507.

For example, in FIG. 16, if the predetermined number is set to four, the job addition counts 1601 for the reservation numbers “GU2P” and “AL9I” are each less than or equal to the predetermined number. For the reservation number “UT8I”, the job addition count 1601 is five, which is not less than or equal to the predetermined number.

In the case of the reservation number “UT8I”, since the job addition count 1601 of the number of times an additional job of a newly approved document for printing is previously associated is not less than or equal to the predetermined number, the processing proceeds to step S507. In step S507, the print management cloud service 104 does not associate the newly approved document for printing with the reservation number “UT8I”. The print management cloud service 104 issues a new reservation number 1206 using the reservation number issuance control unit 424 and adds a reservation number record to the reservation number list 1600. Thereafter, the print management cloud service 104 associates the newly issued reservation number 1206 with the job record of the newly approved document for printing. The reservation number record of the reservation number “UT8I” is retained.

In step S506, the print management cloud service 104 associates the reservation number 1206 stored in the reservation number list 1600 and associated with the user of the client terminal 101 with the job record of the newly approved document for printing. Thereafter, the processing proceeds to step S1502.

In step S1502, after associating the existing reservation number with the newly approved document for printing, the print management cloud service 104 adds 1 to the field of the job addition count 1601 of the reservation number record of the corresponding reservation number in the reservation number list 1600.

Thereafter, the processing proceeds to step S1301.

As described above, the CPU 211 repeats the plurality of printing approval request processes. Then, in step S501, the CPU 211 receives, from the client terminal 101 of the first account (requester), a printing approval request for one or more other documents to the second account (approver).

In step S502, the CPU 211 transmits the printing approval request for the one or more other documents to the client terminal 102 of the second account.

In step S503, the CPU 211 receives, from the client terminal 102 of the second account, a printing approval determination result for each document in response to the printing approval request for the one or more other documents.

In step S504, if there is an approved document for printing (approved) in the printing approval determination results received in step S503, the processing proceeds to step S505.

In step S505, if the documents associated with the first reservation identifier have not been printed, there is a first reservation identifier associated with the first account, so that the processing proceeds to step S1501.

In step S1501, if the count 1601 of the number of times the first reservation identifier is associated with a document for which a printing approval request has been issued is less than or equal to a threshold, the processing proceeds to step S506. Further, if the count 1601 of the number of times the first reservation identifier is associated with a document for which a printing approval request has been issued is not less than or equal to the threshold, the processing proceeds to step S507.

In step S506, the CPU 211 associates the first reservation identifier with the document approved for printing.

After the associating, in step S1302, the CPU 211 transmits the email 1400 or 1410 to the client terminal 101 of the first account. The email 1410 includes the printing approval determination result 1411 received for each document in step S503, the first reservation identifier 1412, and the printable documents 1413.

In step S507, the CPU 211 issues a third reservation identifier differing from the first reservation identifier and associates the third reservation identifier with the document approved for printing.

After the associating, in step S1302, the CPU 211 transmits an email to the client terminal 101 of the first account. The email includes the printing approval determination result received for each document in step S503, the third reservation identifier, and the printable documents.

In the foregoing method according to the present exemplary embodiment, a limit is set for the number of times an additional job of a document can be associated with one reservation number. With this method, the user of the client terminal 101 cannot endlessly input the same reservation number to the multi-function apparatus 103 to print documents, providing a reduced risk of information leakage.

### Other Exemplary Embodiments

The present disclosure can also be realized by a process in which a program for carrying out one or more functions of the above-described exemplary embodiments is supplied to a system or an apparatus via a network or a storage medium and one or more processors of a computer of the system or the apparatus read the program and execute the read program. Further, the present disclosure can also be realized with a circuit (e.g., application-specific integrated circuit (ASIC)) configured to carry out the one or more functions.

The present disclosure also encompasses systems configured by combining the above-described exemplary embodiments as appropriate and functions of the systems.

Further, the above-described exemplary embodiments merely illustrate specific examples of implementation of the present disclosure, and the technical scope of the present disclosure should not be interpreted narrowly by the exemplary embodiments. Specifically, the present disclosure can be implemented in various forms without departing from the technical concept or major features of the present disclosure.

The present disclosure makes it possible to associate a plurality of documents with a single reservation identifier regardless of timings of printing approval determination results for the plurality of documents.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-083307, filed May 19, 2023, which is hereby incorporated by reference herein in its entirety.

What is claimed is:

1. A print management apparatus comprising:
one or more processors; and
one or more memories storing instructions, which when executed by the one or more processors, cause the print management apparatus to:
receive, from a first account, a first printing request for a document to a second account;
transmit, to the second account, a first printing approval request for the document based on the first printing request;
receive, from the second account, first printing approval as a response to the first printing approval request;
manage the document corresponding to the first printing approval in association with a first reservation identifier;
transmit, to the first account, the first reservation identifier;
receive, from the first account, a second printing request for another document to the second account;
transmit, to the second account, a second printing approval request for the other document based on the second printing request;
receive, from the second account, second printing approval as a response to the second printing approval request; and
in a case where the document associated with the first reservation identifier has not been printed, manage the first reservation identifier in further association with the other document corresponding to the second printing approval,
wherein the first reservation identifier is an identifier to be input to an image forming apparatus to cause the image forming apparatus to print one or more documents associated with the identifier.

2. The print management apparatus according to claim 1, wherein the instructions, when executed by the one or more processors, further cause the print management apparatus to transmit, to the first account, the first reservation identifier after the first reservation identifier is managed in association with the other document corresponding to the second printing approval.

3. The print management apparatus according to claim 1, wherein the instructions, when executed by the one or more processors, further cause the print management apparatus to:
manage a second reservation identifier differing from the first reservation identifier in association with the other document corresponding to the second printing approval in a case where the second printing approval is received and the document associated with the first reservation identifier has been printed; and
transmit, to the first account, the second reservation identifier.

4. The print management apparatus according to claim 1, wherein the instructions, when executed by the one or more processors, further cause the print management apparatus to manage the first reservation identifier and the document corresponding to the first printing approval in association with a printing deadline.

5. The print management apparatus according to claim 4, wherein in a case where the document associated with the first reservation identifier has not been printed and the printing deadline has not expired, the first reservation identifier is managed in association with the other document corresponding to the second printing approval.

6. The print management apparatus according to claim 4, wherein in a case where the printing deadline has expired, the other document corresponding to the second printing approval is managed in association with a second reservation identifier differing from the first reservation identifier.

7. The print management apparatus according to claim 1, wherein the instructions, when executed by the one or more processors, further cause the print management apparatus to delete the document, a printing deadline for the document and the first reservation identifier in a case where the document associated with the first reservation identifier has been printed or the printing deadline has expired.

8. A print system comprising:
the print management apparatus according to claim 1; and
an image forming apparatus configured to print the document associated with the reservation identifier based on the reservation identifier.

9. A method for a print management apparatus, the method comprising:
receiving, from a first account, a first printing request for a document to a second account;
transmitting, to the second account, a first printing approval request for the document to the second account;
receiving, from the second account, first printing approval as a response to the first printing approval request;
managing the document corresponding to the first printing approval in association with a first reservation identifier;
transmitting, to the first account, the first reservation identifier;
receiving, from the first account, a second printing request for another document to the second account;
transmitting, to the second account, a second printing approval request for the other document based on the second printing request;
receiving, from the second account, second printing approval as a response to the second printing approval request; and
in a case where the document associated with the first reservation identifier has not been printed, managing the first reservation identifier in further association with the other document corresponding to the second printing approval,
wherein the first reservation identifier is an identifier to be input to an image forming apparatus to cause the image forming apparatus to print one or more documents associated with the identifier.
